(19) United States
(12) Patent Application Publication
(10) Pub. No.: US 2026/0200544 A1
(43) Pub. Date: Jul. 16, 2026

(54) MOBILE SECURITY TRAILER AND FRAME

(71) Applicant: RV Mobile Power, LLC, Columbus, OH (US)

(72) Inventor: Jimmy Conroy, Columbus, OH (US)

(73) Assignee: RV Mobile Power, LLC, Columbus, OH (US)

(21) Appl. No.: 19/024,755

(22) Filed: Jan. 16, 2025

(51) Int. Cl. B62D 63/08; B62D 63/06; G03B 17/56; G03B 29/00

(52) U.S. Cl. CPC B62D 63/08; B62D 63/061; G03B 17/561; G03B 29/00

(57) ABSTRACT

This disclosure includes various embodiments of a mobile security trailer having a trailer frame with a front beam and a tongue extending perpendicular to the front beam, a base positioned so that a first portion of the base is positioned over the tongue while a second portion of the base is positioned over the front beam; a telescoping camera boom attached to the base, and a security camera assembly positioned at the top of the telescoping camera boom. Some embodiments include a port side storage compartment positioned on a port side of the frame, a starboard side storage compartment positioned on a starboard side of the frame, and a center channel positioned between the port side storage compartment and the starboard storage compartment.

### BACKGROUND

Solar-powered mobile security trailers are versatile, self-contained units designed to provide surveillance and security in remote or temporary locations without requiring a constant power supply from the grid. These trailers are equipped with solar panels that convert sunlight into electricity, which is stored in batteries to power cameras, lights, communication devices, and other security equipment. Solar-powered mobile security trailers are increasingly popular in industries like construction, oil and gas, and events management, where temporary yet reliable security solutions are essential. Their ability to operate independently and sustainably makes them a valuable asset for protecting assets and ensuring safety in diverse environments.

However, the design of these trailers must be able to withstand the attempts at vandalism and tampering that can come from having a device out in the public for extended periods of time. Not only tampering is an issue, but also the strength, stability, and flexibility of the frame when under dynamic loads either from towing/transport or from high winds.

### SUMMARY

Disclosed herein are various embodiments of a mobile security trailer system with an improved frame. Some embodiments of the frame for use in the system contain a rectangular base with one or more oblique beams connecting inside the rectangular base. One or more of the oblique beams may contain an open channel on the top side of the beam. Where the oblique beam connects to the side beams, there may be a gap between the beveled end of the oblique beams and the lateral beam. Where the oblique beams connect to a medial beam, a medial plate may be positioned above this location and covering one or more of the beveled ends of the oblique beams. Also located where the oblique beams connect to a medial beam, a medial plate may be positioned above this location and covering one or more of the open channels of the oblique beams.

A plurality of extension sleeves may be positioned parallel to the nearest oblique beam and each may contain a horizontal frame extension which moves within a horizontal plane while travelling inside and outside of the extension sleeve to extend the footprint of the trailer. Most of the rectangular frame may be located within a horizontal plane that is above the plane containing the sleeve and its extension. A base which connects to a telescoping camera boom may have a portion which is atop the front beam of the frame with a larger portion being positioned atop the tongue of the trailer.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

These drawings illustrate certain aspects of some of the embodiments of the present disclosure and should not be used to limit or define the disclosure.

FIG. 1 is a right-side projection view of one embodiment of an exemplary mobile security trailer system.

FIG. 2 is a top elevation view of one embodiment of the trailer frame used in embodiments of the mobile security trailer system shown in FIG. 1 and showing the location of Detail A.

FIG. 3 is a detailed top elevation view of Detail A shown in FIG. 2.

FIG. 4 is a top elevation view of one embodiment of the trailer frame used in embodiments of the mobile security trailer system shown in FIG. 1 and showing the location of Detail B.

FIG. 5 is a detailed top elevation view of Detail B shown in FIG. 4.

FIG. 6 is a left-side perspective view of one embodiment of the trailer frame used in some embodiments of the mobile security trailer system shown in FIG. 1, where the solar panel mast and telescoping camera boom are shown mounted to this embodiment of the frame, and the locations for Detail C and Detail D are also shown.

FIG. 7 is a detailed perspective view of Detail C shown in FIG. 6.

FIG. 8 is a detailed perspective view of Detail D shown in FIG. 6.

FIG. 9 is a left side projection view of an embodiment of the trailer frame used in some embodiments of the mobile security trailer system shown in FIG. 1.

### DETAILED DESCRIPTION

10 mobile security trailer system
20 top solar panel
22 bottom solar panel
25 solar panel mast
26 mounting plate
30 security camera assembly
31 satellite antenna
35 telescoping camera boom
38 base
38a portion of base atop front beam
38b portion of base atop the tongue
40 swivel jack
42 horizontal frame extension
45 hitch
50 boom winch
55 port side storage compartment
56 starboard side storage compartment
60 center channel
65 wheel
70 displacement gap
100 trailer frame
102 trailer tongue
110 rectangular pan
112 vertical wall
150 front frame portion
160 rear frame portion
170 front beam
171 front edge of front beam
175 rear beam
180 side beam
200 rectangular base
201 medial beam
205 front oblique beam
206 rear oblique beam
215 front gap
216 rear gap
225 beveled end
250 rear medial plate
260 front medial plate
270 lateral beam
301 medial centerline of rectangular base and tongue
350 centerline of front frame portion
360 centerline of rear frame portion
370 lateral centerline
400 portside front extension sleeve
405 starboard front extension sleeve
410 portside rear extension sleeve
415 starboard rear extension sleeve
420 open channel
430 closed top
440 frame plane
450 extension sleeve plane

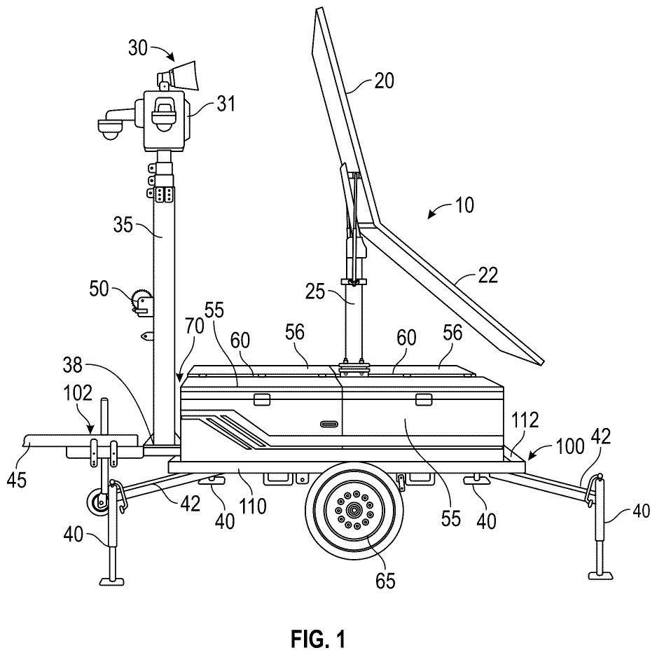

FIG. 1 is a right-side projection view of one embodiment of an exemplary mobile security trailer system 10. This embodiment may include a trailer frame 100 having a rectangular pan 110 with a vertical sidewall 112 extending upwardly from the outer perimeter of the rectangular pan 110. A trailer tongue 102 may extend in the forward direction from the rectangular pan 110 with a hitch 45 positioned at the forward end of the trailer tongue 102. The trailer frame 100 is supported by two or more wheels 65 which may be positioned directly underneath a solar panel mast 25 which may extend upwardly from the rectangular pan 110 to support one or more solar panels. In this embodiment, the solar panel mast 25 supports a top solar panel 20 along with a bottom solar panel 22. A horizontal frame extension 42 may extend horizontally away from the trailer 100 at each corner with a swivel jack 40 attached to the end of each frame extension 42 such that the swivel jack 40 is attached so that it can rotate approximately 90 degrees and then expand/lengthen in a downward direction until making contact with the ground.

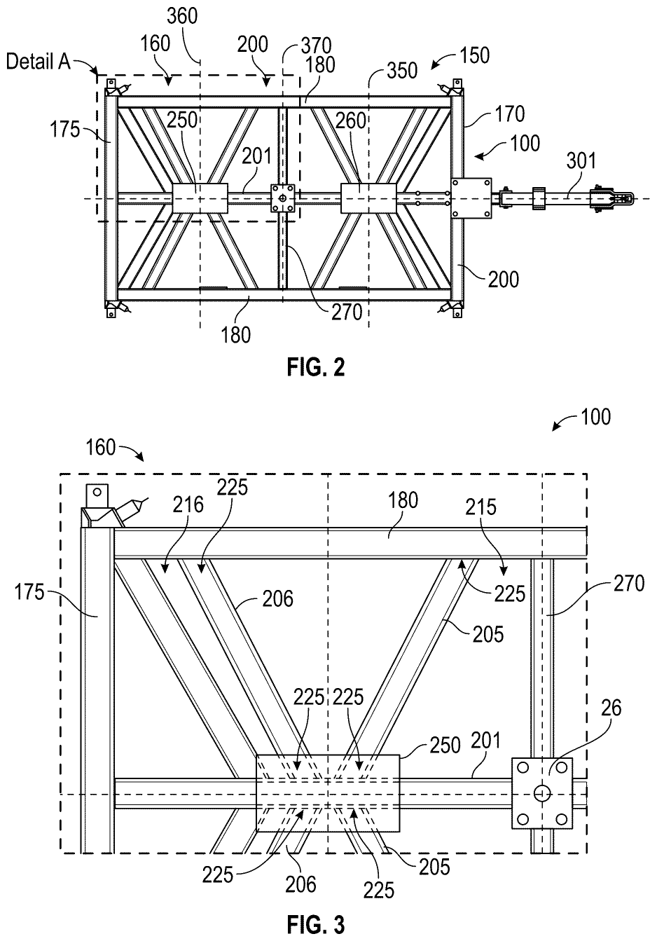

A port side storage compartment 55 may be positioned within the pan 110 and may be a single compartment, or a combination of two or more compartments placed immediately adjacent to one another. In this particular embodiment, two port side storage compartments 55 are used, each having their own enclosure and door for access. Similarly, a starboard side storage compartment 56 may also be positioned within the pan 110 and may also be a single compartment, or a combination of two or more compartments placed immediately adjacent to one another. In this particular embodiment, two starboard side storage compartments 56 are used, each having their own enclosure and door for access. In some embodiments, a center channel 60 is positioned between the port side compartment 55 and the starboard side compartment 56 and may run the entire length of the trailer frame 100 substantially parallel to and above the medial centerline 301 (shown in FIG. 2). Each compartment 55/56 may contain one or more components for operating and communicating with the mobile security trailer system 10 which may include but is not limited to: a generator, fuel tank for generator, batteries, solar charge controller, and related electronics for operating the same.

A telescoping camera boom 35 may be positioned forward of the rectangular pan 110 and extending upwardly from a base 38 with a portion that is positioned above the tongue 102. A displacement gap 70 may be located between the telescoping camera boom 35 and one or both of the compartments 55 and 56. It has been discovered that this gap 70 can provide a number of benefits including but not limited to allowing a slight bending or flex in the camera boom 35 without forcing it to be too stiff and also helps to prevent damage to the compartments 55 and 56 during dynamic loading of the camera boom.

A boom winch 50 may be placed on the forward side (facing the tongue 102) of the boom 35 and may be used to raise and lower the boom 35. A security camera assembly 30 may be positioned atop the boom 35 and may contain one or more security cameras having any number of features including motion sensing, night vision, thermal vision, and similar. A satellite antenna 31 may be placed on the backside (facing the solar panels 20/22) of the housing for the camera assembly 30 and may be used to communicate, either through the internet or otherwise, data from the system 10 to a remote location.

FIG. 2 is a top elevation view of one embodiment of the trailer frame 100 used in embodiments of the mobile security trailer system 10 shown in FIG. 1 and showing the location of Detail A. A rectangular base 200 may be defined generally by a front beam 170 which is substantially parallel to a rear beam 175 with a pair of side beams 180 which connect which the front and rear beams 170/175, together forming a rectangular shape. A medial beam 201 may be positioned down the center of the trailer 100 and aligned with and above a medial centerline 301. A lateral beam 270 may connect orthogonally between the side beams 180 and may be generally parallel to the front and rear beams 170/175. The lateral beam 270 may be parallel to and aligned with a lateral centerline 370. The trailer 100 and rectangular base 200 can also be described as having a front frame portion 150 and a rear frame portion 160 which are each generally rectangular and may be square in some embodiments. The front frame portion 150 and rear frame portion 160 may share the lateral beam 270.

The rear frame portion 160 may be generally symmetrical about a centerline 360, while the front frame portion 150 may be generally symmetrical about a centerline 350. A rear medial plate 250 may be positioned near the center of the rear frame portion 160, while a front medial plate 260 may be positioned near the center of the front frame portion 150. Each medial plate 250/260 may be rectangular with the long side of the rectangle positioned parallel to the medial centerline 301. In some embodiments, each medial plate 250/260 may be bifurcated by the medial centerline 301. In some embodiments, the rear medial plate 250 may be bifurcated by the centerline 360 and the front medial plate 260 may be bifurcated by the centerline 350.

FIG. 3 is a detailed top elevation view of Detail A shown in FIG. 2. Here a closer look at the details of the rear frame portion 160 are shown where a front oblique beam 205 may be positioned so that a first (inside) beveled end 225 is attached at an oblique angle to the medial beam 201 near the intersection of the medial beam 201 with the centerline 360. A second (outside) beveled end 225 on the opposing end of the front oblique beam 205 may be attached at an oblique angle to the side beam 180 in a position rear of the lateral beam 270. In some embodiments there is a gap 215 between the second beveled end 225 of the front oblique beam 205 and the lateral beam 270. Similarly, a rear oblique beam 206 may be positioned so that a first beveled end 225 is attached at an oblique angle to the medial beam 201 near the intersection of the medial beam 201 with the centerline 360. A second beveled end 225 on the opposing end of the rear oblique beam 206 may be attached at an oblique angle to the side beam 180 in a position forward of the rear beam 175. In some embodiments there is a gap 216 between the second beveled end 225 of the rear oblique beam 206 and the rear beam 175. The front oblique beam 205 and the rear oblique beam 206 may form a “V” shape which is symmetrical about the centerline 360. The front oblique beam 205 may be attached at an oblique angle to the medial beam 201 near the centerline 360 and may then extend forwardly while the rear oblique beam 206 may be attached at an oblique angle to the medial beam 201 near the centerline 360 and may then extend rearwardly. As shown in FIGS. 2 and 3, the front and rear frame portions may each have a total of four oblique beams where each oblique beam is attached at a beveled end 225 the to the medial beam 201 near the centerline 360 and may be attached at an oblique angle. The rear medial plate 250 may be positioned so that it covers the beveled ends 225 of all four oblique beams 205/206 within the rear frame portion 160. Similarly, the front medial plate 260 may be positioned so that it covers the beveled ends 225 of all four oblique beams 205/206 within the front frame portion 150. The rear medial plate 250 and front medial plate 260 may be attached to a top surface of the medial beam 201 and also sometimes a top surface of the oblique beams 205/206 as well.

A mounting plate 26 for the solar panel mast 25 may be positioned at the intersection of the medial beam 201 with the lateral beam 270 and may be bifurcated in both directions by the centerline 360 and the medial centerline 301. The mounting plate 26 may be symmetrical about both the centerline 360 and the medial centerline 301, or just one of them.

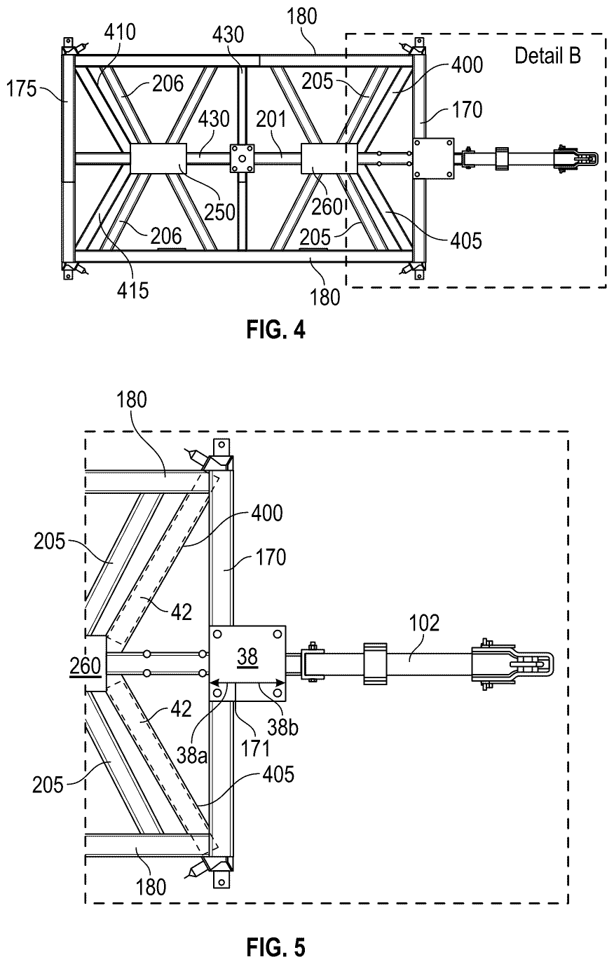

FIG. 4 is a top elevation view of one embodiment of the trailer frame 200 used in embodiments of the mobile security trailer system shown in FIG. 1 and showing the location of Detail B. In this embodiment, an extension sleeve (400, 405, 410, and 415) may be positioned near each of the four corners of the rectangular base 200 where each extension sleeve may be substantially parallel with the nearest oblique beam (205 and 206). Specifically, a portside front extension sleeve 400 may be positioned so that it is substantially parallel to the front oblique beam 205 and further such that a first (outer) end is located at the intersection of the front beam 170 with the side beam 180 while a second (inner) end is located on the medial beam 201 near the front medial plate 260. Similarly, a starboard front extension sleeve 405 may be positioned substantially parallel to the front oblique beam 205 and further such that a first (outer) end is located at the intersection of the front beam 170 with the side beam 180 while a second (inner) end is located on the medial beam 201 near the front medial plate 260.

Similarly, a portside rear extension sleeve 410 may be positioned substantially parallel to the rear oblique beam 206 and further such that a first (outer) end is located at the intersection of the rear beam 175 with the side beam 180 while a second (inner) end is located on the medial beam 201 near the rear medial plate 250. Finally, a starboard rear extension sleeve 415 may be positioned substantially parallel to the rear oblique beam 206 and further such that a first (outer) end is located at the intersection of the rear beam 175 with the side beam 180 while a second (inner) end is located on the medial beam 201 near the rear medial plate 250.

In some embodiments, the medial plates 250 and 260 may cover a portion of the second (inner) end of the extension sleeves 400, 405, 410, and 415. In some embodiments, the rear extension sleeves 410 and 415 would not be parallel to the rear beam 175 but would be angled relative to the rear beam 175. In some embodiments, the front extension sleeves 400 and 410 would not be parallel to the front beam 170 but would be angled relative to the front beam 170.

FIG. 5 is a detailed top elevation view of Detail B shown in FIG. 4. Here the front portion of the trailer is shown in detail, specifically the tongue 102 which extends forwardly from the front beam 170. A base 38 may be placed atop both the front beam 170 as well as the tongue 102 such that the base 38 contains portion 38a which is the portion of the base which is atop the front beam and portion 38b which is the portion of the base which is atop the tongue 102. In some embodiments, 38b is larger than 38a, and in some embodiments 38b is at least twice as large as 38a. In further embodiments, 38b is at least three times as large as 38a, while other embodiments 38b is at least four times as large as 38a. It has been discovered that these arrangements can provide improved strength to the trailer, stability of the camera mast, stiffness of the tongue, and additional weight on the tongue which is beneficial in some instances.

Each of the extension sleeves 400, 405, 410, and 415 may contain a horizontal frame extension 42 which may be a rectangular or circular cross-shape rigid element that is capable of sliding inside the sleeve entirely for stowing during transport and then sliding outside of the sleeve to extend the overall footprint of the trailer. Each horizontal frame extension 42 may be parallel to its corresponding extension sleeves 400, 405, 410, and 415 and may have cross-sectional geometry that is substantially similar with the interior dimensions of the sleeve being slightly larger than the exterior dimensions of the frame extension 42 to ensure clearance between the two as the frame extension 42 moves horizontally back and forth.

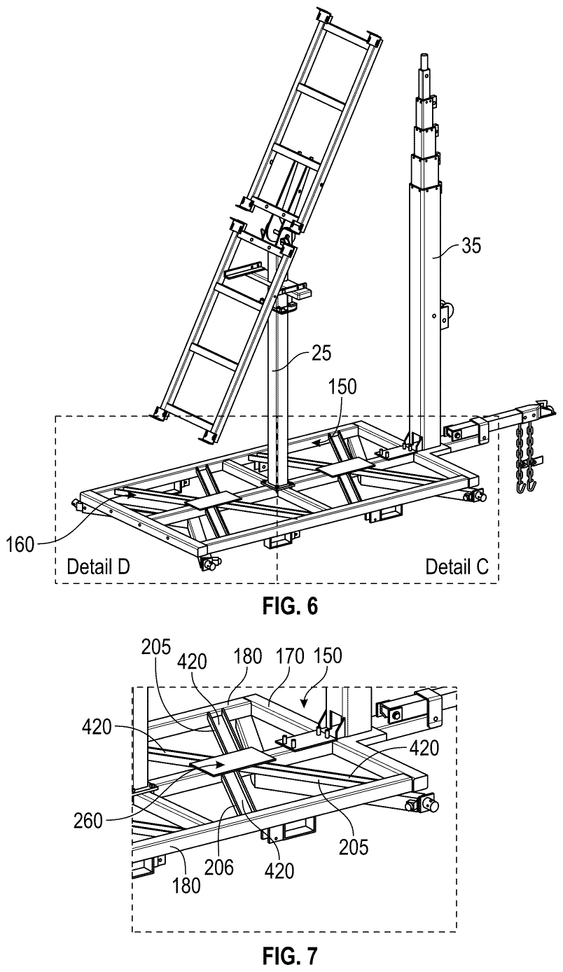

FIG. 6 is a left-side perspective view of one embodiment of the trailer frame used in some embodiments of the mobile security trailer system shown in FIG. 1, where the solar panel mast 25 and telescoping camera boom 35 are shown mounted to this embodiment of the frame, and the locations for Detail C and Detail D are also shown. Generally speaking, Detail C provides a detailed view front frame portion 150 while Detail D provides a detailed view of the rear frame portion 160.

FIG. 7 is a detailed perspective view of Detail C shown in FIG. 6. Each oblique beam 205/206 may include an open channel 420 facing upwardly, in other words on the top side of the beam 205/206. In some embodiments, each oblique beam 205/206 may be a “C channel” beam with the open portion of the “C” facing upwardly. In some embodiments, each oblique beam 205/206 may be a “U channel” beam with the open portion of the “U” facing upwardly. In some embodiments, only one beam 205 or 206 may be oriented with the channel 420 facing upwardly, while the remaining beams 205 and/or 206 may have a different orientation or may be a different type of beam. The front medial plate 260 may cover a portion of one or more of the open channels 420, or may cover the inner portion of one or more of the open channels 420 (the portions which are located near the medial beam 201 and may also be within the center channel 60 (shown in FIG. 1) which is generally located above the medial beam 201.

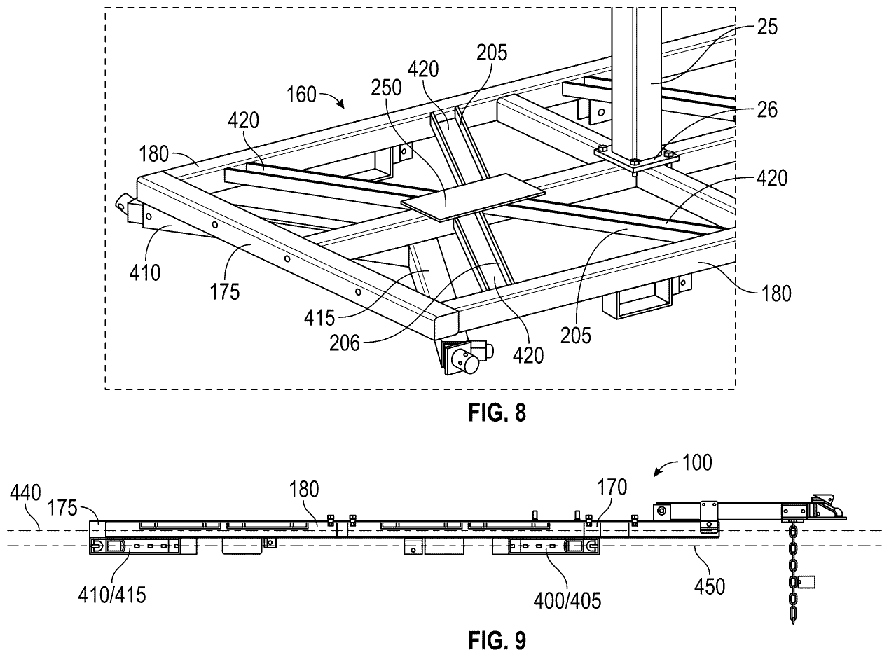

FIG. 8 is a detailed perspective view of Detail D shown in FIG. 6. Similar to the front frame portion 150, one or more of the oblique beams 205/206 within the rear frame portion 160 may include an open channel 420 facing upwardly, in other words on the top side of the beam 205/206. In some embodiments, the beams 180, 170, 205, and 206 may all be positioned within the same horizontal plane while the extension sleeves 400, 405, 410, and 415 may all be positioned beneath the plane containing the beams.

FIG. 9 is a left side projection view of an embodiment of the trailer frame used in some embodiments of the mobile security trailer system shown in FIG. 1. In some embodiments, the beams 180, 170, 205, and 206 may all be positioned within a first plane (frame plane 440) while the extension sleeves 400, 405, 410, and 415 may all be positioned within a second plane (extension sleeve plane 450) with the second horizontal plane being positioned beneath the first horizontal plane. In some embodiments, the horizontal frame extensions 42 are positioned within the extension sleeve plane 450 while stowed and remain positioned within the extension sleeve plane 450 once extended outside the sleeves and away from the trailer (see FIG. 1). When the extensions 42 slide in and out of the sleeves 400, 405, 410, and 415 they may remain within the extension sleeve plane 450 during the movement.

Although the present disclosure and its advantages have been described in detail, it should be understood that various changes, substitutions and alterations may be made herein without departing from the spirit and scope of the disclosure as defined by the appended claims. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited. Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

I claim:

1. A mobile security trailer comprising:
a trailer frame comprising a front beam and a tongue extending perpendicular to the front beam;
a base positioned so that a first portion of the base is positioned over the tongue while a second portion of the base is positioned over the front beam;
a telescoping camera boom attached to the base; and
a security camera assembly positioned at a top end of the telescoping camera boom.

2. The mobile security trailer of claim 1 further comprising:
a port side storage compartment positioned on a port side of the frame;
a starboard side storage compartment positioned on a starboard side of the frame; and
a center channel positioned between the port side storage compartment and the starboard side storage compartment.

3. The mobile security trailer of claim 2 wherein:
the center channel is positioned above a medial centerline of the trailer frame.

4. The mobile security trailer of claim 2 wherein:
the center channel is parallel to the tongue.

5. The mobile security trailer of claim 2 further comprising:
a displacement gap positioned between the telescoping camera boom and the port side storage compartment.

6. The mobile security trailer of claim 2 further comprising:
a solar panel mast extending upwardly from the center channel; and
one or more solar panels attached to the solar panel mast.

7. The mobile security trailer of claim 2 further comprising:
a corner defined by an intersection of the front beam with a side beam; and
a extension sleeve positioned at the corner; and
a horizontal frame extension positioned within the extension sleeve.

8. The mobile security trailer of claim 7 further comprising:
a swivel jack attached to the horizontal frame extension.

9. The mobile security trailer of claim 7 further comprising:
a medial beam positioned parallel to a centerline of the trailer frame; and
an oblique beam connecting between the side beam and the medial beam and positioned substantially parallel to the extension sleeve.

10. A mobile security trailer comprising:
a trailer frame comprising
a front beam,
side beams extending rearwardly from the front beam,
a tongue extending forwardly and perpendicular to the front beam,
a medial beam positioned along a medial centerline of the trailer frame and aligned with the tongue, and
an oblique beam connecting between the medial beam and the side beam where the oblique beam is connected an oblique angle to both the medial beam and the side beam;
a base positioned with a portion above the front beam;
a telescoping camera boom attached to the base; and
a security camera assembly positioned at a top of the telescoping camera boom.

11. The mobile security trailer of claim 10 further comprising:
a medial plate attached to the medial beam and centered on the medial centerline of the trailer frame.

12. The mobile security trailer of claim 10 further comprising:
an open channel positioned along the oblique beam.

13. The mobile security trailer of claim 12 wherein:
the open channel is “U” shaped and facing upwardly.

14. The mobile security trailer of claim 10 further comprising:
an extension sleeve positioned substantially parallel to the oblique beam; and
a horizontal frame extension positioned within the extension sleeve.

15. The mobile security trailer of claim 12 further comprising:
a medial plate positioned over a portion of the open channel.

16. The mobile security trailer of claim 10 further comprising:
a port side storage compartment positioned on a port side of the frame;
a starboard side storage compartment positioned on a starboard side of the frame;
a center channel positioned between the port side storage compartment and the starboard side storage compartment; and
a medial plate attached to a top surface of the medial beam and positioned within the center channel.

17. A mobile security trailer comprising:
a trailer frame comprising a front beam and a tongue extending perpendicular to the front beam;
a base positioned so that a first portion of the base is positioned over the tongue while a second portion of the base is positioned over the front beam;
a telescoping camera boom attached to the base;
a security camera assembly positioned at a top end of the telescoping camera boom;
a port side storage compartment positioned on a port side of the frame;
a starboard side storage compartment positioned on a starboard side of the frame;
a center channel positioned between the port side storage compartment and the starboard side storage compartment; and
a displacement gap between the port side storage compartment and the telescoping camera boom.

18. The mobile security trailer of claim 17 wherein:
the displacement gap is aligned with the center channel.

19. The mobile security trailer of claim 18 wherein:
the displacement gap further extends between the starboard side storage compartment and the telescoping camera boom.

20. The mobile security trailer of claim 17 further comprising:
an extension sleeve positioned underneath the port side storage compartment; and
a horizontal frame extension positioned within the extension sleeve.
